(19) United States
(12) Patent Application Publication
(10) Pub. No.: US 2015/0333876 A1
(43) Pub. Date: Nov. 19, 2015

(54) METHOD AND APPARATUS FOR A MODIFIED HARQ PROCEDURE AFTER A RECEIVER OUTAGE EVENT

(71) Applicants: ZTE WISTRON TELECOM AB, Kista (SE); ZTE (TX) INC., Austin, TX (US)

(72) Inventors: Patrick SVEDMAN, Kista (SE); Jan JOHANSSON, Kista (SE); Thorsten SCHIER, Kista (SE); Bojidar HADJISKI, Kista (SE); Aijun CAO, Kista (SE); Yonghong GAO, Kista (SE)

(21) Appl. No.: 14/651,572

(22) PCT Filed: Dec. 11, 2013
(86) PCT No.: PCT/US13/74489

§ 371 Date: Jun. 11, 2015

Related U.S. Application Data
(60) Provisional application No. 61/737,047, filed on Dec. 13, 2012.
(60) Provisional application No. 61/737,041, filed on Dec. 13, 2012.

(51) Int. Cl. H04L 1/18

(52) U.S. Cl. CPC H04L 1/1819; H04L 1/1896

(57) ABSTRACT

A system and method of responding to a receiver outage event, which includes: determining if a receiver outage event has occurred; if a receiver outage event has occurred, discarding soft bits that were corrupted due to the outage event; and if a received first redundancy version (RV) of coded bits corrupted by the outage event was decoded incorrectly, sending a message to a transmitter in response to the outage event, and thereafter receiving a second RV of coded bits retransmitted by the transmitter in response to the message.

### RELATED PATENT APPLICATIONS

This application claims benefit of priority under 35 U.S.C. §119(e) to Provisional Application No. 61/737,047, entitled “Method and Apparatus for a Modified HARQ Procedure After a Receiver Outage Event,” filed Dec. 13, 2012, and to U.S. Provisional Application No. 61/737,041 entitled “Method And Apparatus For A Blocking Detector In A Digital Communication System,” also filed Dec. 13, 2012, each of which are incorporated by reference herein in their entireties.

### FIELD OF THE INVENTION

The present invention relates generally to digital communication systems and methods and, more particularly, to procedures for retransmission of data following a receiver outage event.

### BACKGROUND OF THE INVENTION

In many digital communication links there is an information transmitter and an information receiver. There is also typically a feedback link between the information receiver and the information transmitter such that the transmitter can receive “side information” from the receiver.

For example, many digital communication systems use Automatic Repeat reQuest (ARQ) protocols, including Hybrid ARQ (HARQ) protocols. In such systems, a block of information is sent from a transmitter to a receiver. If the block is correctly received, the receiver responds to the transmitter with an acknowledgement (ACK). Otherwise, the receiver responds with a negative acknowledgement (NACK).

FIG. 1 illustrates a block diagram of an exemplary conventional digital communication system 100 capable of transmitting a block of digital information. The communication system 100 includes a transmitter 102 and a receiver 104 capable of receiving information from the transmitter 102 via a communications channel 106, which can be any known communications medium.

The transmitter 102 includes a Cyclic Redundancy Check (CRC) module 110, which receives information symbols for transmission and performs CRC processing on the information symbols to output the information symbols and CRC error-correcting codes. The information symbols and CRC codes are then provided to a Forward Error Correction (FEC) encoder 112, for encoding the information symbols and CRC codes, which results in a set of coded bits. In some implementations, the information symbols plus CRC codes can be split into several smaller blocks, which are encoded separately. Furthermore, in some implementations, additional CRC codes can also be added to these smaller blocks. In some implementations, the coded bits which are the output of the encoding of the several smaller blocks constitute the whole set of coded bits.

A subset of the coded bits (which could be the whole set in some implementations) is then selected by a subset selector module 114 for transmission to the receiver 104. The receiver 104 is also informed of which subset of the coded bits, sometimes called the redundancy version (RV), were transmitted by the transmitter 102. In some cases, the coded bits can be divided into systematic bits and parity bits. If Chase Combining (CC) is used there is only one RV. If Incremental Redundancy (IR) is used there can be more than one RV.

FIG. 2 illustrates an exemplary block diagram showing how information symbols and CRC codes are encoded into coded bits and thereafter selected to form RV subsets (e.g., RV 0, RV 1 and RV 2). The subset(s) of coded bits are then modulated onto an analog waveform by a modulation module 116 in accordance with a desired format and protocol and transmitted on the designated channel 106 to the receiver 104. These waveforms can be corrupted in the communication channel. Furthermore, the receiver can receive unwanted noise and interference at the same time as a wanted information-bearing waveform.

A demodulation module 118 of the receiver 104 receives the analog waveforms and demodulates the waveforms to extract discrete-valued samples corresponding to the coded bits, also called soft bits. In some implementations, a Forward Error Correction (FEC) decoder 120 of the receiver 104 decodes the coded bits and obtains a set of information bits. A CRC Check module 122 then performs a CRC check and/or other suitable checks to evaluate if the obtained information bits were correctly transmitted and decoded.

The information receiver 104 transmits an ACK/NACK (Negative Acknowledge Character) to the information transmitter over the feedback link. If the information transmitter obtains an ACK (Acknowledge Character), it considers the information block to be successfully communicated. If the information transmitter obtains a NACK, it may retransmit coded bits. A different RV (a different set of coded bits) than in the previous transmission may be used. In the example in which CC is used, the same RV is used in the retransmission, since there is only one RV. If IR is used, then a different RV can be used in the retransmission than in the previous transmission.

In general, more than one retransmission may be necessary before the information block is successfully communicated. In one implementation, a sequence of RVs is transmitted, i.e. the RV of the first transmission, the RV of the first retransmission, etc. If CC is used, there is only one possible sequence of RVs, consisting of a single RV in each transmission. If IR is used, there are many different possible sequences of RVs. Typically, some RV sequences give better performance than others. For example, it is often better to transmit systematic bits in the first transmission rather than only parity bits. The combination of FEC and retransmissions is often called Hybrid Automatic Repeat reQuest (HARQ).

As described above, the receiver receives a sum of the wanted information-bearing waveform, other interfering signals and noise. A receiver typically has a range of input signal powers that it can handle. If the input signal power is too low, the signal cannot be resolved. If the input signal power is too high, the signal typically cannot be resolved either due to corruption and distortion or other factors. This phenomenon is often referred to as receiver blocking. The too high power example can be due to too high power on the wanted signal, interference of too high power, or other factors. In many cases, the blocking lasts only as long as the input power is too high, i.e. the recovery time can be very short. When a receiver is blocked, all received signals may be corrupted, even if their corresponding powers were on a suitable level. The blocking itself can occur in the analog parts or in the digital parts of the receiver. In the analog parts, for example, the input signal can be in the non-linear range of the electronic components, resulting in signal saturation in some examples. In the digital parts, for example, the sample magnitude may be insufficient to represent the high power signal, resulting in signal saturation.

If the receiver is a receiver of wireless signals, the high interference power can come from a transmitter, e.g. a mobile phone, that is communicating with another receiver that is much further away than the blocked receiver or other suitable transmitters and is, therefore, transmitting at a high transmit power. One example scenario is when the blocked receiver is in a femto base station with a closed subscriber group (CSG) and the interfering mobile is close to the femto, but does not belong to the CSG. In this case, the interfering mobile may be required to use high transmit power to reach another base-station, e.g. a macro base station, thereby interfering with signals intended to reach the blocked receiver.

Another example is a cell with distributed antennas, for example an LTE soft cell or other suitable topologies. A mobile close to a receiving antenna transmits a random access signal (in LTE: the random access preamble) to connect to the network, using a transmit power based on the pathloss from another distant antenna. This would be possible if the close receiving antenna is not configured to transmit common pilot signals (in LTE: called cell-specific reference signal, CRS), which the mobile uses to determine the transmit power of the random access signal. In this case, the transmitted random access signal can block the receiver of the close antenna, due to the high power.

The following references are incorporated by reference herein in its entireties.
1. U.S. Pat. No. 7,865,201 entitled “HARQ Data Reception In Multiradio Device.”
2. U.S. Patent Patent Publication No. 2009/0086657 A1 entitled “Hybrid Automatic Repeat Request Buffer Flushing Mechanism.”
3. Dahlman, Parkvall, Skold, “4G LTE/LTE-Advanced for Mobile Broadband”, Academic Press, 2011.

### SUMMARY OF THE INVENTION

In one embodiment, the invention provides a method and system for receiving retransmitted data after a receiver outage event, the method including: determining if a receiver outage event has occurred; if a receiver outage has occurred, discarding soft bits obtained during the outage event; and if a block was decoded incorrectly due to the outage event, sending a message to a transmitter in response to the outage event and thereafter receiving a redundancy version (RV) of coded bits retransmitted by the transmitter in response to the message.

In a further embodiment, coded bits are transmitted and the coded bits include systematic bits and parity bits, and if the receiver outage occurs during transmission of systematic bits, a RV containing systematic bits is selected for retransmission instead of a RV with parity bits.

In a further embodiment, the invention provides a method and system for retransmitting data after a receiver outage event, wherein the method includes: receiving a message from a receiver for which an outage event has occurred; and retransmitting a selected redundancy version (RV) of coded bits to the receiver in response to the message.

In further embodiments, the message transmitted to the transmitter includes a request for the transmitter to select a RV for retransmission to the receiver.

### BRIEF DESCRIPTION OF THE DRAWINGS

The figures are provided to facilitate the reader's understanding of the invention and should not be considered limiting of the breadth, scope, or applicability of the invention. It should be noted that for clarity and ease of illustration these figures are not necessarily drawn to scale.

FIG. 1 illustrates a block diagram showing some of the components of an exemplary conventional digital communication system.

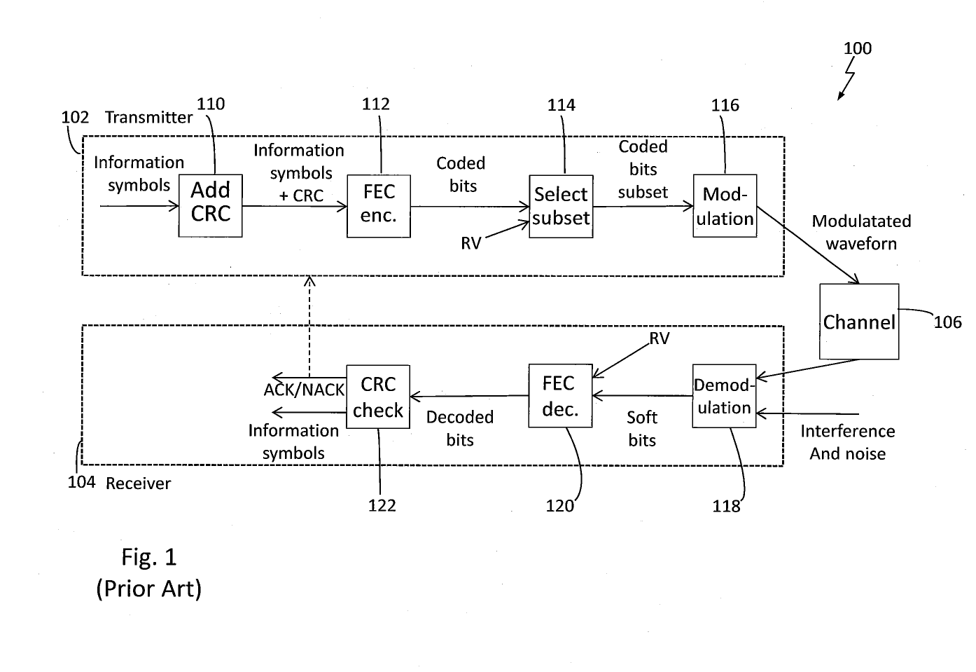

FIG. 2 illustrates a process diagram showing how information symbols may be converted into coded bits of revision versions (RV's) in conventional digital communication systems.

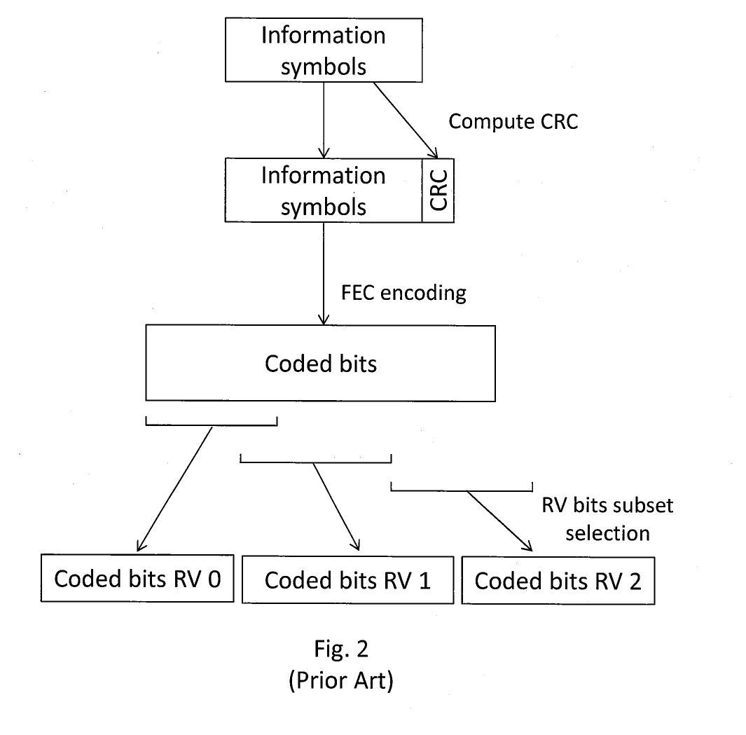

FIG. 3 is a flow chart of a modified HARQ procedure in accordance with one embodiment of the invention.

### DETAILED DESCRIPTION OF EXEMPLARY EMBODIMENTS

Exemplary embodiments, reference is made to the accompanying drawings which form a part hereof, and in which it is shown by way of illustration of specific embodiments in which the invention may be practiced. It is to be understood that other embodiments may be utilized and structural changes may be made without departing from the scope of the preferred embodiments of the invention.

In many transmission systems, it can be assumed that the receiver has received all the previously transmitted redundancy versions. If all redundancy versions provide the same amount of information about the data packet, the order of the redundancy versions is not critical. However, for some code structures, various redundancy versions are not necessarily of equal importance. One example is Turbo codes, where the systematic bits may be of higher importance than the parity bits. Hence, the initial transmission may advantageously include all the systematic bits and some parity bits. In the retransmission(s), parity bits not in the initial transmission can be included. However, if the initial transmission was received with poor quality or not at all, a retransmission with only parity bits is not necessarily appropriate as a retransmission of (at least some of) the systematic bits provides better performance.

Incremental redundancy with Turbo codes can therefore benefit from multiple levels of feedback. In one embodiment, two different negative acknowledgements are used—NACK to request additional parity bits and LOST to request a retransmission of the systematic bits. In general, the problem of determining the amount of systematic and parity bits in a retransmission based on the signal quality of previous transmission attempts is non-trivial.

During a receiver outage, the receiver does not function normally. A receiver outage can be due to various factors including but not limited to a receiver blocking (as described above), a temporary power failure in parts of the receiver, a circuit glitch in the receiver, etc. During a receiver outage, the received signal can be severely corrupted or lost. Hence, if a failed transmission is due to a receiver outage, increased transmission reliability measures, e.g. higher transmit power or lower channel coding rate, is typically not helpful.

In accordance with one embodiment of the invention, it is assumed that a receiver quickly recovers after an outage. Typically, the outage duration is in the order of milliseconds or less, although other outage durations are possible in other embodiments to which the principles of the invention are applicable. Furthermore, in one embodiment, the following is assumed:
1. A receiver can detect that it is in outage (for example, it can detect that it is blocked as discussed above).
2. A receiver can over the feedback link either
   a. inform a transmitter (of wanted information) that it is in outage, and/or
   b. request the transmission of a certain RV.
3. The receiver uses soft combining, i.e. the soft bits of each transmission of an information block are combined to improve the likelihood of successful decoding (but see below regarding assumption 3 in some embodiments). Soft bits are well-known to persons of ordinary skill in the art and generally refer to information used by a receiver to determine the likelihood that a transmitted “hard bit” is either a 0 or 1 (a “regular” bit), for example. Typically, soft bits can have more than two levels to represent the likelihood that the transmitted hard bit was either a 0 or 1. For example, if a soft bit has a large positive magnitude, it is likely that the transmitted hard bit was 1. If the soft bit value is around 0, then it may indicate that it is equally likely that either a 1 or 0 was transmitted. If a soft bit has a large negative magnitude, it is likely that the transmitted hard bit was 0.
4. During a receiver outage, a transmitter transmits one or more information-bearing transmissions. The temporal overlap between the transmissions and the outage is such that some received soft bits are corrupted.
5. Multiple transmitters may transmit transmissions to the receiver during the outage, using any kind of multiplexing (time, frequency, code, etc.).

According to one embodiment, a method of the invention includes the following steps. When an outage is detected in a receiver, the following two events 1(a) and 1(b) take place:
1. If the decoding of an overlapping transmission results in a NACK, then
   a. The receiver discards soft bits obtained from the transmission that occurred during the outage.
      i. In one implementation, discarding soft bits means that they are not used in the soft combining
      ii. In one implementation, all soft bits of the transmission are discarded, even those bits that were not corrupted by the outage.
      iii. In one implementation, only the soft bits that were corrupted by the outage are discarded, which means that the other soft bits can be used in the decoding.
      iv. Other implementations are used in other embodiments
      v. As such, in some embodiments assumption 3 above is modified. Not all transmissions of an information block are necessarily used in the soft combining
   b. Either:
      i. In one embodiment, the receiver informs the transmitter that it was in outage during the transmission. In one embodiment, the receiver uses a negative acknowledgement of the type LOST, as mentioned above, to inform the transmitter. The transmitter then selects an RV based on this information. In one embodiment, the transmitter can choose to retransmit the RV that was in outage instead of proceeding to the next RV in the RV sequence that is used under normal conditions.
      ii. In one embodiment, the receiver, based on the information about the outage event, requests the transmitter to select a particular RV for the retransmission. In one embodiment, the receiver requests the transmitter to retransmit the RV that was in outage instead of proceeding to the next RV in the RV sequence that is used under normal conditions. In one embodiment, the receiver uses a negative acknowledgement of the type LOST, as mentioned above, to request particular RV from the transmitter.

The disclosure provides the advantage of combining an outage detector with the events of both 1(a) and 1(b) to avoid receiver outage and the significant performance loss associated with receiver outage.

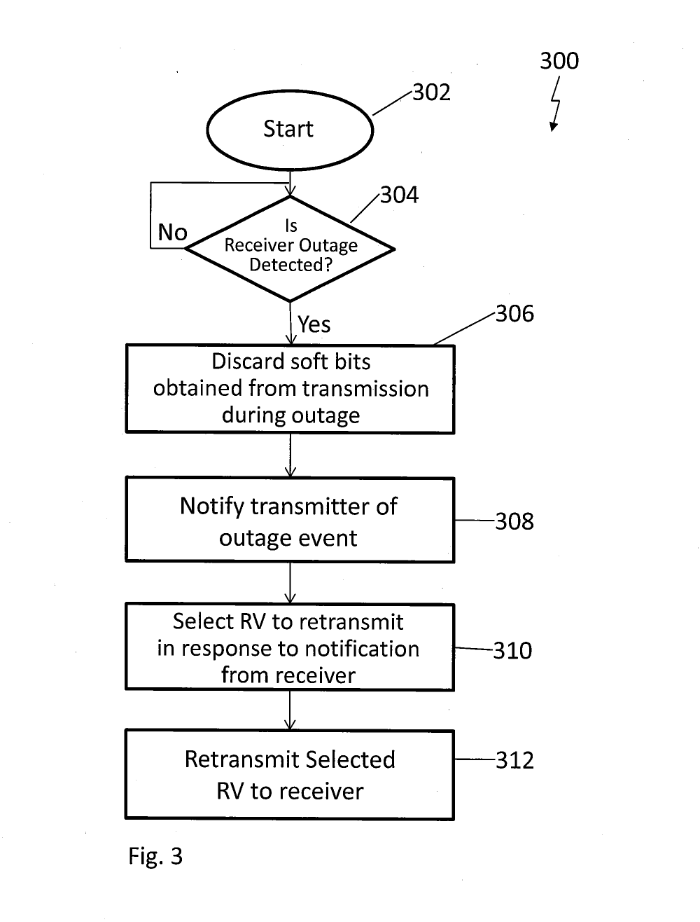

FIG. 3 illustrates a flow chart of a modified HARQ procedure after a receiver outage event, in accordance with one embodiment of the invention. The procedure 300 starts at step 302 and proceeds to step 304 where it is determined if a receiver outage is detected. If the answer is “No,” then the process returns to step 304 until a receiver outage is detected. If a receiver outage is detected at step 304, then at step 306, the receiver 102 discards soft bits obtained during the outage. In one embodiment, all soft bits transmitted during the outage are discarded even if they were not corrupted as a result of the outage. In an alternative embodiment, only corrupted soft bits are discarded.

Next, at step 308, the receiver 102 notifies the transmitter 104 of the outage event. In one embodiment, the notification by the receiver 102 can include a request that the transmitter 104 selects the redundancy version (RV) that was being transmitted at the time of the outage for retransmission instead of the RV the transmitter 104 might otherwise normally retransmit. In one embodiment, the notification sent by the receiver 102 to the transmitter 104 in step 308 includes a negative acknowledgement of the type LOST, which indicates that a RV was corrupted by the outage event. Next, at step 310, the transmitter 104 selects a RV for retransmission in response to the notification from the receiver 102. In one embodiment, the transmitter will select for the next retransmission a RV that corresponds to a previous RV that was corrupted due to the outage event. In another embodiment, the transmitter 104 will select a specific RV requested by the receiver 102. At step 312, the transmitter retransmits the selected RV to the receiver 102.

In one embodiment, the receiver 102 may be part of a mobile communication device (not shown), and the transmitter 104 may be part of a base station. In an alternative embodiment, the receiver 102 may be part of a base station and the transmitter 104 may be part of a mobile device.

In some embodiments, the coded bits are divided into at least systematic bits and parity bits. If outage occurs during the transmission of systematic bits, the RV containing these systematic bits is advantageously retransmitted instead of moving on to an RV with parity bits. On the other hand, if an RV with only parity bits was transmitted during a receiver outage, it is less important to retransmit this particular RV. Therefore, in some embodiments, a RV with only parity bits transmitted during a receiver outage is not requested to be retransmitted. In a further embodiment, a RV with systematic bits is requested to be transmitted instead.

The word “exemplary” is used herein to mean “serving as an example or illustration.” Any aspect or design described herein as “exemplary” is not necessarily to be construed as preferred or advantageous over other aspects or designs.

While one or more embodiments of the invention have been described above, it should be understood that they have been presented by way of example only, and not by way of limitation. Likewise, the various figures or diagrams may depict an example architectural or other configuration, which is done to aid in understanding the features and functionality that can be included in the invention. The invention is not restricted to the illustrated example architectures or configurations, but can be implemented using a variety of alternative architectures and configurations.

One or more of the functions described in this document may be performed by an appropriately configured module. The term “module” as used herein, refers to software that is executed by one or more processors, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according to various embodiments of the invention.

Additionally, one or more of the functions described in this document may be performed by means of computer program code that is stored in a “computer program product”, “computer-readable medium”, and the like, which is used herein to generally refer to media such as, memory storage devices, or storage unit. These, and other forms of computer-readable media, may be involved in storing one or more instructions for use by processor to cause the processor to perform specified operations. Such instructions, generally referred to as “computer program code” (which may be grouped in the form of computer programs or other groupings), which when executed, enable the computing system to perform the desired operations.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate units, processors or controllers may be performed by the same unit, processor or controller. Hence, references to specific functional units are only to be seen as references to suitable means for providing the described functionality, rather than indicative of a strict logical or physical structure or organization.

What is claimed is:

1. A method of responding to a receiver outage event, comprising:
determining if a receiver outage event has occurred;
if a receiver outage event has occurred, discarding soft bits that were corrupted due to the outage event; and
if a received first redundancy version (RV) of coded bits corrupted by the outage event was decoded incorrectly, sending a message to a transmitter in response to the outage event, and thereafter receiving a second RV of coded bits retransmitted by the transmitter in response to the message.

2. The method of claim 1 wherein the coded bits of the first RV include systematic bits and parity bits, and if the receiver outage occurs during reception of systematic bits, a RV containing systematic bits is selected for the next retransmission as the second RV instead of a RV with parity bits.

3. The method of claim 2 wherein if a RV with only parity bits was transmitted during the receiver outage, the RV with only parity bits is not selected for a next retransmission.

4. The method of claim 1, wherein all soft bits received during the outage are discarded even if they were not corrupted as a result of the outage.

5. The method of claim 1 wherein only soft bits that were corrupted during the outage event are discarded.

6. The method of claim 1 wherein the message includes a request for the transmitter to select a RV for retransmission to the receiver.

7. The method of claim 1 wherein the message notifies the transmitter of the outage event.

8. The method of claim 1 wherein a RV that was corrupted due to the outage event is selected for the next retransmission.

9. The method of claim 1 wherein the message notifies the transmitter that a block was not decoded correctly due to the outage event.

10. The method of claim 1 wherein the message notifies the transmitter that a RV was received during the outage event.

11. The method of claim 1 wherein the message comprises a negative acknowledgement of the type LOST, which indicates that a RV was corrupted by the outage event.

12. A method of retransmitting data after a receiver outage event, comprising:
receiving a message from a receiver for which an outage event has occurred; and
retransmitting a selected redundancy version (RV) of coded bits to the receiver in response to the message.

13. The method of claim 12 wherein the coded bits include systematic bits and parity bits, and if the receiver outage occurs during transmission of systematic bits, a RV containing systematic bits is selected for retransmission instead of a RV with parity bits.

14. The method of claim 13 wherein if a RV with only parity bits was transmitted during the receiver outage, the RV with only parity bits is not selected for retransmission.

15. The method of claim 12, wherein the message comprises a request that a transmitter selects a RV that was being transmitted at the time of the outage event for retransmission.

16. The method of claim 12 wherein the message comprises a negative acknowledgement of the type LOST, which indicates that a RV was corrupted by the outage event.

17. The method of claim 12 wherein the message notifies the transmitter of the outage event.

18. The method of claim 12 wherein the message includes a request for the transmitter to select a RV for retransmission.

19. The method of claim 12 wherein the message notifies the transmitter that a block was not decoded correctly due to the outage event.

20. The method of claim 12 wherein the message notifies the transmitter that a RV was received during the outage event.
